(19) United States
(12) Patent Application Publication
(10) Pub. No.: US 2012/0219787 A1
(43) Pub. Date: Aug. 30, 2012

(54) CONDUCTIVE METAL PASTE COMPOSITION AND METHOD OF MANUFACTURING THE SAME

(75) Inventors: Byung Ho JUN, Seoul (KR); Dong Hoon KIM, Gyeonggi-do (KR); Su Hwan CHO, Seoul (KR); Jeong Min CHO, Gyeonggi-do (KR)

(73) Assignee: SAMSUNG Electro-Mechanics Co., Ltd.

(21) Appl. No.: 13/327,363

(22) Filed: Dec. 15, 2011

(30) Foreign Application Priority Data
Feb. 28, 2011 (KR) 10-2011-0017831
Oct. 26, 2011 (KR) 10-2011-0109937

(51) Int. Cl. B32B 5/16; B05D 5/12; H01B 1/22

(52) U.S. Cl. 428/328; 252/512; 252/513; 252/514; 427/58

(57) ABSTRACT

A conductive metal paste composition including conductive metal particles including first metal particles having a particle size of less than 100 nm, and second metal particle of particle size greater than 100 nm, and a surface coated with a capping material; a binder; and a solvent, a method of manufacturing the same, and an electrode and a conductive circuit of an electronic device using the same. The paste composition containing two or more kinds of conductive metal particles with different particle sizes can secure high conductivity compared to a conventional metal pastes during low temperature or short-time medium and high temperature sintering.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0017831, entitled filed Feb. 28, 2011, which is hereby incorporated by reference in its entirety into this application.

### BACKGROUND OF THE INVENTION

1. Field of the Invention

The present invention relates to a conductive metal paste composition, a method of manufacturing the same, and electrodes and conductive circuits of various electronic devices using the same, and more particularly, to a conductive metal paste composition having high conductivity and sinterable at a low temperature, a method of manufacturing the same, and electrodes and conductive circuits of various electronic devices using the same.

2. Description of the Related Art

A conductive paste is used in an insulating substrate and a process requiring low temperature sintering. At this time, a paste composition using silver or gold is mainly used. However, since silver or gold is expensive, an inexpensive paste to replace this is required. Especially, a conductive paste composition, which can be used in a wide temperature range from low temperature sintering to high temperature sintering.

In recent times, an attempt has been made to use a relatively inexpensive copper (Cu) paste in various electrical and electronic devices.

In order to manufacture a conventional conductive copper paste, like FIG. 1, a method of mixing micro-scale metal particles and plate-like sub-micro particles or particles with a smaller size than the sub-micro particles is used. However, a copper paste manufactured by the above method requires an expensive post-process to secure uniform mixing and high dispersibility between particles and there is a difficulty in securing high conductivity by low temperature sintering.

Further, like FIG. 2, a method of making a paste by mixing nano-sized metal particles with a dispersible resin is proposed. However, in this method, the surface area of the particles is increased by the small size of the particles. Therefore, an organic dispersant content for maintaining dispersibility is increased and thus there are disadvantages that viscosity of the paste is greatly increased compared to a paste with the same metal content and volume contraction is increased during sintering.

Meanwhile, a paste composition should be sinterable at a low temperature, preferably, at a temperature below 200° C. in order to form an electrode by printing a conductive metal paste on a substrate containing polymer, glass, amorphous silicon, and so on, which is not suitable for high temperature processes. However, in case of currently used conductive metal paste compositions, since they have a sintering temperature above 300° C., they are difficult to be applied to the above technology fields.

Therefore, in order to perform low temperature sintering, a nano phenomenon (melting point depression) is needed, and a conductive metal paste composition to satisfy this is required.

### SUMMARY OF THE INVENTION

The present invention has been invented in order to overcome the above-described problems and it is, therefore, an object of the present invention to provide a conductive metal paste composition sinterable at a low temperature, having high dispersibility, and capable of forming a high density conductive circuit.

It is another object of the present invention to provide a method of manufacturing the conductive metal paste composition.

It is still another object of the present invention to provide electrodes and conductive circuits of various electronic devices using the conductive metal paste composition.

In accordance with one aspect of the present invention to achieve the object, there is provided a conductive metal paste composition including: conductive metal particles including first metal particles having a particle size of less than 100 nm and a surface coated with a capping material and second metal particles having a particle size of greater than 100 nm; a binder; and a solvent.

The capping material coated on the surface of the first metal particle may include —N— and —O— elements in a molecule.

It may be preferred that the capping material is fatty acid or aliphatic amine.

The capping material may be included in the entire paste composition by 0.01 to 25 wt %.

The conductive metal may be one or more selected from the group consisting of copper, silver, gold, nickel, platinum, palladium, and salts thereof.

It may be preferred that the first metal particles and the second metal particles are included at a weight ratio of 1:1 to 1:30.

The binder may be one or more selected from the group consisting of cellulose resin, acrylic resin, epoxy resin, vinyl resin, imide resin, amide resin, and butyral resin.

The solvent may be one or more selected from one or more organic solvents selected from the group consisting of toluene, methyl ethyl ketone, and methyl isobutyl ketone; one or more nonpolar solvents selected from the group consisting of palanil oil, tetradecane, tetralin, and mineral oil; and one or more polar solvents selected from the group consisting of propyl alcohol, isopropyl alcohol, terpineol, butyl carbitol, and neodecanate.

The conductive metal paste composition may include 50 to 95 wt % of the conductive metal particles including the first metal particles and the second metal particles, 0.01 to 10 wt % of the binder, and the balance of the solvent.

The conductive metal paste composition has a characteristic that it is sinterable below 200° C.

Further, in accordance with another aspect of the present invention to achieve the object, there is provided a method of manufacturing a conductive metal paste composition including the steps of: manufacturing first metal particles coated with a capping material; and adding the first metal particles and a binder to a second metal particle dispersion solution.

In accordance with an embodiment of the present invention, the step of manufacturing the first metal particles may include the steps of forming a metal precursor containing a first metal, reducing the metal precursor in a high temperature atmosphere, and coating a surface of the metal precursor with the capping material.

The first metal particles and the second metal particles may be mixed at a weight ratio of 1:1 to 1:30.

Further, the present invention may be provided to form electrodes and conductive circuits of various electronic devices using the conductive metal paste composition.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 shows the shape of mixed paste particles in a paste composition in accordance with the prior art;

FIG. 2 shows the shape of conventional conductive paste particles consisting of only nano particles;

FIG. 3 shows the shape of conductive paste particles in accordance with an embodiment of the present invention; and

FIGS. 4 and 5 show the shape of electrode patterns manufactured in accordance with fifth and sixth embodiments of the present invention.

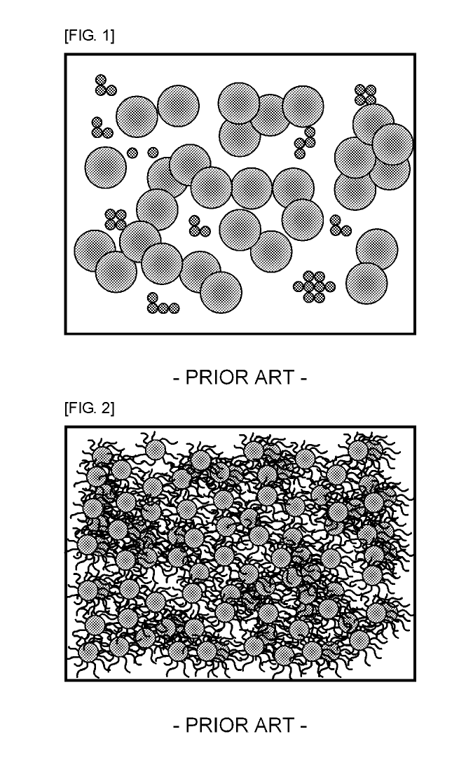

### DETAILED DESCRIPTION OF THE PREFERABLE EMBODIMENTS

The terms used in the present specification are used to describe a particular embodiment, not limiting the present invention. As in the present specification, a singular form may include a plural form unless the context clearly indicates otherwise. The terms “comprise” and/or “comprising” specify existence of shapes, numbers, steps, operations, members, elements, and/of groups thereof, which are referred to, and do not exclude existence or addition of one or more different shapes, numbers, operations, members, elements, and/or groups thereof.

The present invention provides a conductive metal paste composition having high dispersibility and low temperature sinterability or capable of securing high conductivity by being sintered at medium and high temperatures in a short time.

The conductive metal paste composition of the present invention for obtaining the above effects includes metal particles, a binder, and a solvent. Especially, the metal particles include two or more kinds of particles of different particle sizes. Specifically, the metal particles include first metal particles having a particle size of less than 100 nm and a surface coated with a capping material and second metal particles having a particle size of greater than 100 nm.

The first metal particle has a particle size of less than 100 nm, preferably less than 10 nm. Since the first metal particle has a small particle size, it plays a role of reducing a sintering temperature. Therefore, a metal paste can be sintered at a low temperature or sintered at medium and high temperatures in a short time.

Further, the first metal particle has a structure in which an outer portion is coated with a capping material.

The capping material is to improve dispersibility of the metal paste. Specifically, it is preferred that —N— and —O— elements are included in a molecule of the capping material. It is preferred that the capping material coated on the surface of the first metal particle is fatty acid or aliphatic amine.

The fatty acid is one or more selected from the group consisting of lauric acid, oleic acid, decanoic acid, and palmitic acid, but is not limited thereto.

Further, the aliphatic amine is one or more selected from the group consisting of octylamine, decylamine, dodecyclamine, oleylamine, 2-ethylhexylamine, and hexadecylamine, but is not limited thereto.

It is preferred that the capping material is included in the entire paste composition by 0.01 to 25 wt %. In case of less than 0.01 wt %, there is a problem of deterioration of the dispersibility of the paste. In case of exceeding 25 wt %, it is not preferable due to deterioration of printability of the paste and reduction of a conductive material content.

Here, various kinds of materials may be used as the capping material. As an example, various kinds of fatty acids may be used as the capping material. Copper nano particles capped with this capping material can be manufactured by various manufacturing methods previously filed by the applicant. As an example, according to Korean Patent Application No. 2005-72478, it is possible to obtain metal nano particles, which are capped with alkanoic acid, that is, fatty acid such as lauric acid, oleic acid, decanoic acid, and palmitic acid by using a copper compound functioning as a reducing agent. As another example, according to Korean Patent Application No. 2005-66936, it is possible to cap fatty acid around metal nano particles by heat-treating metal alkanoate. As still another example, according to Korean Patent Application No. 2006-64481, it is possible to obtain metal nano particles capped with fatty acid by using a salt of metal such as tin, magnesium, and iron after dissociating a metal precursor in the fatty acid. As still another example, according to Korean Patent Application No. 2006-98315, it is possible to obtain copper nano particles capped with fatty acid by dissociating a copper precursor material in the fatty acid and heating the mixture or adding a reducing agent. As still another example, it is possible to use metal nano particles capped with aliphatic amine. In this case, like Korean Patent Application No. 2006-127697, it is also possible to use particles simultaneously including two kinds of dispersants, that is, fatty acid and aliphatic amine. Since these methods are just examples, a method of preparing metal nano particles capped with fatty acid is not limited thereto and various methods can be used.

Since the first metal particles of the present invention have a structure coated with a capping material, it is possible to secure dispersibility of the first metal particles.

However, in the conductive metal paste composition, when using a small particle with a nanometer particle size like the first metal particle, there is an advantage that the particle can be sintered at a low temperature. Further, as a diameter of the conductive metal particle is reduced, coating characteristics of the conductive metal paste and electrical characteristics of a conductive pattern formed by using the conductive metal paste can be improved. This is because sinterability is improved by improvement of thermal reactivity as the diameter of the conductive metal particle is reduced.

While the conductive metal particle has the above characteristics according to size reduction, there is a disadvantage that there is too large volume contraction in a sintering process. Therefore, there are many problems such as disconnection or short of wiring, patterns, and circuits or occurrence of cracks due to the excessive volume contraction in drying and sintering processes.

Therefore, in order to compensate the volume contraction of this nanometer metal particle, a conductive metal with a particle size of greater than 100 nm is added to minimize the volume contraction during sintering.

In the present invention, it is preferred that a mixing ratio of the first metal particles and the second metal particles is a weight ratio of 1:1 to 1:30. When out of the above range, it is not preferred because the volume contraction due to sintering is excessive or low-temperature sinterability is deteriorated.

Further, it is preferred that the first metal particle and the second metal particle are conductive metal, specifically, one or more selected from the group consisting of copper, silver, gold, nickel, platinum, palladium, and salts thereof, but are not limited thereto. Among them, copper is preferable in terms of price.

As above, the present invention can provide a paste composition capable of securing high dispersibility and conductivity in low temperature sintering or short-time sintering by mixing the first metal particles with a small particle size of less than 100 nm, which secure dispersibility through coating of the capping material, and the second metal particles with a particle size of greater than 100 nm, which are larger than the first metal particles.

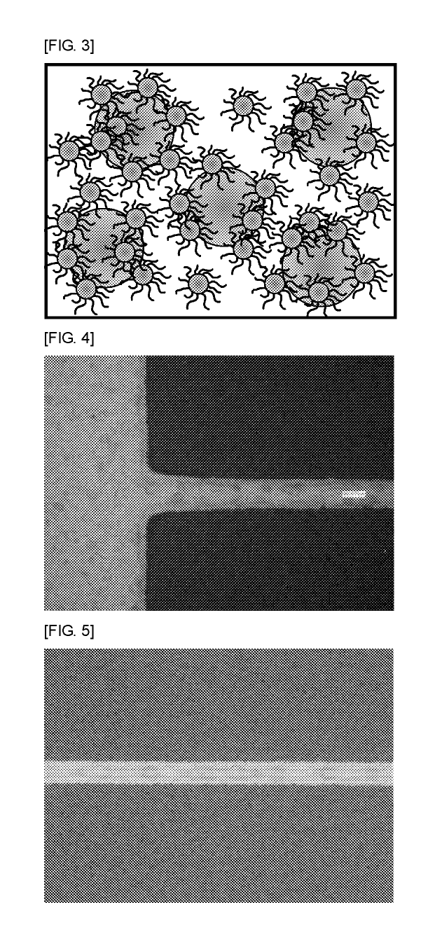

Further, it is possible to secure high conductivity by excellent component combination of the second metal particles with a relatively low specific surface area compared to the first metal particles and the first metal particles advantageous for low temperature sintering or short-time high temperature sintering. Further, in case of the first metal particle with dispersibility, its dispersibility is also excellent, but as shown in FIG. 3, it is possible to manufacture a metal paste with high dispersibility by dispersing the first metal particle on a surface between the second metal particles to remove agglomeration between the second metal particles.

By the addition of these first metal particles with dispersibility, it is possible to secure the paste composition of low viscosity excellent enough to secure dispersibility only by simple mixing without a conventional complex expensive post-process and to minimize the amount of the binder added to the paste composition.

It is preferred that viscosity of the conductive metal paste in accordance with the present invention is 10,000 to 1,000,000 cps.

Further, the binder used in the conductive metal paste composition of the present invention may be one or more selected from the group consisting of cellulose resin, acrylic resin, epoxy resin, vinyl resin, imide resin, amide resin, and butyral resin, but is not limited thereto.

Further, the solvent used in the conductive metal paste composition of the present invention may be selected from one or more organic solvents selected from the group consisting of toluene, methyl ethyl ketone, and methyl isobutyl ketone; one or more nonpolar solvents selected from the group consisting of palanil oil, tetradecane, tetralin, and mineral oil; and one or more polar solvents selected from the group consisting of propyl alcohol, isopropyl alcohol, terpineol, butyl carbitol, and neodecanate, but is not limited thereto.

The conductive metal paste composition of the present invention may include 50 to 95 wt % of the conductive metal including the first metal particles and the second metal particles, 0.01 to 10 wt % of the binder, and the balance of the solvent.

Further, the conductive metal paste composition of the present invention can be sintered at a low temperature below 200° C. Further, the conductive metal paste composition of the present invention can be sintered at a temperature exceeding 200° C. for a short time.

Hereinafter, a method of manufacturing a conductive metal paste composition in accordance with the present invention will be described in detail. The method of manufacturing a conductive metal paste composition in accordance with the present invention includes the steps of manufacturing first metal particles having a surface coated with a capping material and adding the first metal particles and a binder to a second metal particle dispersion solution.

In accordance with an embodiment of the present invention, the step of manufacturing the first metal particles may include the steps of forming a metal precursor containing a first metal, reducing the metal precursor in a high temperature atmosphere, and coating a surface of the metal precursor with a capping material.

Specifically, a mixture is formed by supplying a compound containing the first metal, a first reducing agent, and a solvent to a predetermined reactor. The step of forming the mixture may be performed in a temperature condition of about 30 to 250° C. Next, the first metal particle having a structure like FIG. 3 is manufactured by adding the capping material to the mixture to coat the surface of the first metal particle with the capping material.

And, when a second reducing agent is added to the mixture, the mixture can react at a high temperature. Here, the first and second reducing agents may be at least one of ascorbic acid, phenolic acid, maleic acid, acetic acid, citric acid, and formic acid.

Through the above process, it is possible to obtain a reaction composition containing the substantially spherical first metal particles with a particle size of less than 100 nm. The first metal particles can be finally obtained by a post-process of the reaction composition such as cooling, cleaning, and centrifugation.

The second step manufactures a conductive metal paste composition by adding the manufactured first metal particles and a binder to the second metal particle dispersion solution. The second metal particle dispersion solution is obtained by dispersing second metal particles in the solvent.

It is preferred that the first metal particles and the second metal particles are mixed at a weight ratio of 1:1 to 1:30. The entire conductive metal including the first metal particles and the second metal particles is included in the entire paste composition in the range of 50 to 95 wt %.

Further, the binder is included in the entire paste composition by 0.01 to 10 wt %. Various additives may be added to the paste composition. The additive content is similar to that of a general conductive metal paste composition and is not especially limited.

Since the conductive metal paste composition in accordance with the present invention can be sintered at a low temperature below 200° C., it can be used in forming an electrode on a substrate containing amorphous silicon, polymer, or glass, to which general high temperature processes are difficult to be applied, by a screen printing method or in various electronic devices such as an electrode of a solar cell, wiring of a printed circuit board, and an electrode of an image display device.

Hereinafter, embodiments will be described to help understanding of the present invention. The embodiments of the present invention are provided to more completely explain the present invention to those skilled in the art. The following embodiments may be modified in different forms. The scope of the present invention is not limited by the following embodiments. Rather, these embodiments are provided to make this disclosure thorough and complete and to fully convey the spirit of the invention to those skilled in the art.

### First Embodiment

A paste composition is manufactured by preparing 30 g of first copper particles with a size of 5 nm, which are capped with oleic acid (25 wt %), and mixing the first copper particles in a second copper particle conductive dispersion solution in which 100 g of second copper particles with an average particle size of 0.3 μm are dispersed in a wet solvent (terpineol). The conductive copper particles are included in the entire paste composition by 85 wt %.

Further, a final conductive copper metal paste is obtained by adding ethyl cellulose or an adhesive reinforcing additive to the entire paste composition by 10 wt %.

### Second Embodiment

A conductive copper metal paste composition is manufactured by the same process as the first embodiment except for preparing 20 g of first copper particles with a size of 10 nm, which are capped with dodecyl amine (10 wt %), and mixing the first copper particles in a second copper particle conductive dispersion solution in which 100 g of second copper particles with an average particle size of 3 μm are dispersed in a wet solvent (mixture of terpineol and DHT).

### Third Embodiment and Fourth Embodiment

A copper nano paste manufactured by the first and second embodiments is printed on a substrate for manufacturing a solar cell, on which a transparent conductive oxide is deposited, by a screen printing method. Next, an electrode pattern with a line width of 90 to 100 μm is formed by performing reduction firing at a temperature of 200° C. for 60 minutes.

The formed electrode pattern shows 0.5 to 20 mΩ·cm² of contact resistance and 3 to 30 μΩ·cm of resistivity. Further, it is checked that the electrode pattern is clearly formed without disconnection or short of any pattern.

### Fifth Embodiment and Sixth Embodiment

A copper nano paste manufactured by the first and second embodiments is printed on a polyimide substrate by a screen printing method. An electrode pattern is formed with a line width of 80 μm by performing reduction firing at a temperature of 180° C. for about 30 minutes.

The formed electrode pattern shows 5 to 50 μΩ·cm of resistivity. Further, as shown in FIGS. 5 and 6, the electrode pattern is clearly formed without disconnection or short of any pattern.

From the above results, when using a paste containing two kinds of conductive metal particles with different particle sizes, it is checked that the paste can be sintered at a low temperature below 200° C. Therefore, it is possible to improve sintering characteristics and conductivity without deteriorating dispersibility of a paste as well as to form an excellent pattern by effectively compensating disadvantages of a metal particle with a nanometer size by a metal particle with a relatively large particle size to overcome volume contraction of the metal particle with a size of less than 100 nm.

In accordance with the present invention, the paste composition containing the two or more kinds of conductive metal particles with different particle sizes can secure high conductivity compared to a conventional metal paste during low temperature or short-time medium and high temperature sintering. Therefore, it is possible to implement mass production of a conductive paste material and to improve sintering characteristics at various temperatures by mixing the dispersed nanoparticles and the large conductive metal particles.

Further, it is possible to use the conductive metal paste composition in various electronic devices and to minimize failures such as short, disconnection, and cracks of electrode and conductive circuit patterns formed at this time.

What is claimed is:

1. A conductive metal paste composition comprising:
conductive metal particles including first metal particles having a particle size of less than 100 nm and a surface coated with a capping material and second metal particles having a particle size of greater than 100 nm;
a binder; and
a solvent.

2. The conductive metal paste composition according to claim 1, wherein the first metal particles and the second metal particles are included at a weight ratio of 1:1 to 1:30.

3. The conductive metal paste composition according to claim 1, wherein the capping material coated on the surface of the first metal particle includes —N— and —O— elements in a molecule.

4. The conductive metal paste composition according to claim 3, wherein the capping material is included in the entire paste composition by 0.01 to 25 wt %.

5. The conductive metal paste composition according to claim 1, wherein the conductive metal is one or more selected from the group consisting of copper, silver, gold, nickel, platinum, palladium, and salts thereof.

6. The conductive metal paste composition according to claim 1, wherein the binder is one or more selected from the group consisting of cellulose resin, acrylic resin, epoxy resin, vinyl resin, imide resin, amide resin, and butyral resin.

7. The conductive metal paste composition according to claim 1, wherein the solvent is one or more selected from one or more organic solvents selected from the group consisting of toluene, methyl ethyl ketone, and methyl isobutyl ketone; one or more nonpolar solvents selected from the group consisting of palanil oil, tetradecane, tetralin, and mineral oil; and one or more polar solvents selected from the group consisting of propyl alcohol, isopropyl alcohol, terpineol, butyl carbitol, and neodecanate.

8. The conductive metal paste composition according to claim 1, wherein the conductive metal paste composition includes 50 to 95 wt % of the conductive metal particles including the first metal particles and the second metal particles, 0.01 to 10 wt % of the binder, and the balance of the solvent.

9. The conductive metal paste composition according to claim 1, wherein the conductive metal paste composition is sinterable below 200° C.

10. A method of manufacturing a conductive metal paste composition, comprising:
manufacturing first metal particles coated with a capping material; and
adding the first metal particles and a binder to a second metal particle dispersion solution.

11. The method of manufacturing a conductive metal paste composition according to claim 10, wherein manufacturing the first metal particles comprises:
forming a metal precursor containing a first metal;
reducing the metal precursor in a high temperature atmosphere; and
coating a surface of the metal precursor with the capping material.

12. The method of manufacturing a conductive metal paste composition according to claim 10, wherein the first metal particles and the second metal particles are mixed at a weight ratio of 1:1 to 1:30.

13. An electrode and a conductive circuit of an electronic device using the conductive metal paste composition according to claim 1.
